(19) United States
(12) Patent Application Publication
(10) Pub. No.: US 2015/0304530 A1
(43) Pub. Date: Oct. 22, 2015

(54) AUTOMATIC SCANNER AND METHOD FOR 3D DIGITISATION OF A HUMAN PERIPHERAL CEPHALIC PORTION

(71) Applicant: DIGITEYEZER, Paris (FR)

(72) Inventors: Frederic COURTEILLE, VILLEFRANCHE DE LAURAGAIS (FR); Benoit BOCQUILLON, SAINT ORENS DE GAMEVILLE (FR); Didier CHOLET, BAZIEGE (FR)

(73) Assignee: DIGITEYEZER, Paris (FR)

(21) Appl. No.: 14/384,396

(22) PCT Filed: Feb. 25, 2013
(86) PCT No.: PCT/EP2013/053741

§ 371 Date: Sep. 11, 2014

Related U.S. Application Data
(60) Provisional application No. 61/612,456, filed on Mar. 19, 2012.

(30) Foreign Application Priority Data
Mar. 12, 2012 (FR) 12/00741

(51) Int. Cl. H04N 5/222; H04N 5/247; H04N 13/02; H04N 5/225

(52) U.S. Cl. CPC H04N 5/2224; H04N 5/2252; H04N 5/247; H04N 13/0242; H04N 13/0253; H04N 13/0282

(57) ABSTRACT

A device and a method for three-dimensional digitisation of a human peripheral cephalic portion, in particular including at least part of the face, includes a hollow opaque shell (18) having an opening (25) suitable for receiving the head of a human subject, and forming a photographic chamber incorporating and supporting a plurality of cameras fixed in the photographic chamber and oriented towards the opening, and a lighting device fixed in the photographic chamber and adapted to light the opening and at least part of the peripheral cephalic portion of the head of a human subject placed therein with a homogeneous and controlled light.

The invention relates to a device and a method for three-dimensional digitisation (scanner) of a human peripheral cephalic portion, of the type comprising a plurality of cameras arranged to be able to take a plurality of shots of at least part of said peripheral cephalic portion—in particular from different viewpoints—and a digital data-processing system adapted to be able to generate, from said plurality of shots, a three-dimensional digital model of said peripheral cephalic portion.

A human peripheral cephalic portion is a portion of the body formed of at least one peripheral part of the head, in particular of at least part of the face. It is known that it is possible to produce a three-dimensional virtual model of a human peripheral cephalic portion, for example of human faces, from solely a plurality of photographs taken by digital cameras from different viewpoints—in particular from different shooting angles—. It should be noted that these known, so-called passive, digitising techniques differ from the other, so-called active, 3D digitising techniques, in which patterns are projected onto the object to be digitised.

In particular, the publication “High-Quality Single-Shot Capture of Facial Geometry”, Beeler et al., ACM Transactions on Graphics, SIGGRAPH 2010 vol. 29, no. 3, p. 40, describes such a passive digitising technique and a passive stereo device for capturing 3D images of a face in one step with the aid of standard light sources. This publication mentions the possibility of using a studio comprising seven cameras on stands, or a stereo camera. It mentions the fact of taking photographs with the aid of four cameras or any arbitrary number of cameras. Likewise, the publication “3D Face Reconstruction Using A Single or Multiple Views”, Choi et al. IEEE Computer Society, ICPR 2010, pp. 3959-3962, describes a method for 3D face reconstruction from a single view or multiple different views. This publication mentions the use of five predefined poses, namely one full-face, two half-profile and two profile. The publication “Anthropometric Modeling of Faces from Range Scans”, Yu Zhang and Chew Lim Tan, IJCSNS

International Journal of Computer Science and Network Security, Vol. 7, No. 1, January 2007, pp. 9-20 describes a method for obtaining digital models of complete human heads from 3D data of a portion of the head and from a generic digital model of the head created by software.

Obtaining such a 3D virtual model of a human peripheral cephalic portion such as a face may have numerous applications, for example for the virtual trying of spectacles, cosmetics, hairstyles, or for producing a three-dimensional print of a figurine, or for producing personalised multimedia products such as video games or films, etc.

Moreover, for taking the different shots of a face or a head, there have already been proposed various devices such as automatic photographic booths.

WO 2005033793 describes a transportable photographic device for taking criminal identification photographs, capable of being mounted on a wall or on a supporting container, making it possible to record at least three images in digital form of the face from the front and in profile. The device comprises at least three digital video cameras with corresponding illuminating lamps, namely a front camera, two lateral cameras, and corresponding background sheets. A control device comprising a microprocessor enables control of the entire operation of the device. The device also comprises an automatic height-adjusting system with an ultrasonic height sensor.

None of these known devices are provided or specifically adapted for taking digital images suitable for enabling the formation of a three-dimensional virtual model by a passive digitising technique. In particular, they are either insufficient (the quality of the different shots not being sufficient to enable the passive three-dimensional digitisation), or too complex to use, focus and adjust. In particular, whatever passive digitisation algorithmic technique is used, it is necessary to generate a large number of “3D” points from the different shots taken, and for each of these points, the different shots must be relatively homogeneous, correctly adjusted in terms of focus, exposure, etc.

In addition, the inventors have ascertained that to obtain a 3D virtual model of a face which is sufficiently precise to be able to be utilised in the above-mentioned applications, it is in reality often necessary to use a so-called “dense” passive digitising method, that is to say in which each of the pixels of the virtual model is obtained by triangulation of the pixels of the shots taken. Nevertheless, in this case, the algorithmic computation carried out may be extremely laborious, complex, and long depending on the number of shots and their characteristics. However, the users of 3D virtual models, who may be for example traders or artisans, are not specialists in computing or taking photographs, and these applications require the ability to obtain a virtual model in a period of time compatible with time that is acceptable for a customer to wait.

In this context, the inventors have ascertained that it would be particularly advantageous to be able to have a scanner for three-dimensional digitisation of a human peripheral cephalic portion which simultaneously is extremely simple to use, largely automated, does not require complex computing or photographic adjustment on the part of the user, is inexpensive, accurate, makes it possible to obtain a 3D virtual model quickly (especially with a waiting time acceptable to a customer in a shop—in particular less than five minutes, preferably less than one minute), and with the aid of standard equipment, in particular a simple computer and digital cameras that are commercially available, this 3D virtual model being sufficiently accurate and realistic to enable in particular virtual trying and/or the printing of a figurine realistically depicting the subject.

The invention therefore aims to propose such a device. It also aims to propose a method for three-dimensional digitisation of a human peripheral cephalic portion with the aid of such a device. It aims more particularly to propose such a device and such a method which can be implemented by users who are not specialised in the field of computing or three-dimensional digitisation, for example simple artisan hairdressers or cosmeticians or opticians. To this end, it aims to propose such a device and such a method which may be termed “automatic”, that is to say the photographic, algorithmic and computing operation of which is automated, such that the user has merely to position a human subject whose cephalic portion is to be digitised and possibly to control the triggering of the digitisation.

To this end, the invention relates to a device for three-dimensional digitisation of a human peripheral cephalic portion, comprising a plurality of cameras arranged to be able to take a plurality of shots from different viewpoints of at least part of said peripheral cephalic portion, said plurality of shots being adapted to enable the generation of a three-dimensional digital model of said peripheral cephalic portion from said plurality of shots,

characterised in that it comprises a hollow opaque shell having an opening suitable for receiving the head of a human subject, said shell forming a photographic chamber incorporating and supporting:
a plurality of cameras fixed in the photographic chamber and oriented towards said opening,
a lighting device fixed in the photographic chamber and adapted to light said opening and a peripheral cephalic portion of the head of a human subject placed therein with a homogeneous and controlled light.

The invention also covers a method for three-dimensional digitisation of a human peripheral cephalic portion, with the aid of a device comprising a plurality of cameras arranged to be able to take a plurality of shots from different viewpoints of at least part of said peripheral cephalic portion, said plurality of shots being adapted to enable the generation of a three-dimensional digital model of said peripheral cephalic portion from said plurality of shots,

characterised in that:
the head of a human subject is received in the opening of the shell of a device according to the invention,
said plurality of cameras are triggered so as to take a plurality of shots of a peripheral cephalic portion of the head of a human subject received in the opening,
a three-dimensional digital model of said peripheral cephalic portion of said human subject is produced from said plurality of shots.

With such a device and such a method according to the invention, the taking of the shots necessary for obtaining the virtual model therefore requires no adjustment of the cameras or lighting device, these being preset and fixed with respect to the shell, the whole assembly being itself designed, set and optimised during manufacture to produce the appropriate shots.

Furthermore, advantageously a device according to the invention further comprises a digital data-processing unit connected to the cameras and adapted to be able to generate, from said plurality of shots, a three-dimensional digital model of said peripheral cephalic portion. In a variant, there is nothing to prevent provision being made for the data-processing of the different shots to be performed in a deferred manner and/or transferred to a remote digital processing system, to which the different shots can be transmitted, for example via a computer network such as the Internet network.

When such a processing unit is incorporated in the device according to the invention, advantageously and according to the invention, said digital data-processing unit is also adapted to be able to control the simultaneous triggering of the cameras. This processing unit may also be connected to the lighting device to control the operation thereof. For example, advantageously and according to the invention, said digital processing unit is constituted by a microcomputer central processing unit, and each camera is formed of a webcam with a CMOS sensor and a high-speed universal serial connection (USB 2).

Furthermore, advantageously, a device according to the invention is also characterised in that said photographic chamber extends only on one side of said opening while delimiting it entirely, so that the cameras are adapted to take shots only of one side of the head of a human subject oriented towards the interior of the photographic chamber when this head is placed through said opening. Said data-processing unit is then advantageously adapted to produce a virtual reconstruction from a generic model of the opposite side of the head. Thus, in a method according to the invention, shots are taken only of one side of the head of a human subject oriented towards the interior of the photographic chamber when this head is placed through said opening. And the data processing for obtaining the virtual model—in particular as performed by said data-processing unit—then comprises advantageously a step of virtual reconstruction from a generic model of the opposite side of the head. Advantageously and according to the invention, said side of the head oriented towards the interior of the photographic chamber may be the subject's face, so that the invention enables the three-dimensional digitisation of a face, with virtual reconstruction of the rear portion of the subject's head.

In addition, advantageously and according to the invention, each camera comprises at least one sensor having a resolution greater than one megapixel—in particular of the order of five megapixels—connected to said processing unit and controlled by the latter so as to deliver an image of a size which is less than its resolution—in particular of the order of a tenth of its resolution—. In this way, in a method according to the invention, each image delivered by each camera is a digital image of dimensions less than the resolution of the camera. This results in better precision of each pixel of each image thus obtained. Each shot sensor may be a simple webcam with a CMOS sensor chosen so as to possess sufficient optical quality and sensitivity (in particular signal-to-noise ratio), and a high-speed universal serial connection, in particular USB 2. There is nothing to prevent, in a variant, use of cameras with CCD sensors, which however have the disadvantage of higher cost.

In a digitisation method according to the invention, the shots may be individual images, each camera taking one and only one individual image, which is used as such to obtain the virtual model (in an algorithm of the so-called “multi-view” type). In another variant of a digitisation method according to the invention, the cameras are grouped in pairs, each pair of cameras taking a stereoscopic image, the algorithm for producing the virtual model then being of the so-called “multi-stereoscopic” type. In addition, preferably, the virtual model is produced from the shots, without projecting patterns onto said human cephalic portion, that is to say using a dense passive method. The invention is nevertheless also applicable to a digitisation method in which a projection of patterns is performed to obtain at least some of the shots used in the algorithmic production of the virtual model, and this may enable improvement of the accuracy. Nevertheless, the inventors have ascertained that such a projection is in reality not necessary by virtue of an apparatus according to the invention, the combination of features of which makes it possible in practice to obtain a virtual model of very good quality (in any case of sufficient quality for its utilisation by most of the above-mentioned applications envisaged) in an amply acceptable time, less than five minutes, typically less than one minute, most often of the order of a few seconds.

Advantageously, a device according to the invention comprises a number of cameras of between 6 and 12, for example equal to 7, 9 or 11 when each camera is adapted to take individual shots, or equal to 6 (3 pairs), 8 (4 pairs) or 10 (5 pairs) when the cameras are grouped in pairs adjacent to each other in order to take stereoscopic shots. Preferably, all the cameras of a device according to the invention are identical, that is to say possess technical characteristics which are theoretically identical (except for manufacturing variations).

In any event, advantageously, in a device according to the invention, the different cameras are fixed in the photographic chamber so that their respective lenses are situated at a distance of between 10 cm and 100 cm from said opening. The distance of each camera away from said opening is preferably at least substantially constant (from one camera to another), and is chosen according to the aperture angle of the lens of the camera.

Furthermore, advantageously and according to the invention, the cameras are fixed in the photographic chamber such that their optical axes are coplanar and oriented to converge towards said opening at different angles from one another.

In addition, a device according to the invention for the digitisation of faces is characterised in that said shell is supported with respect to a support so that said opening extends at least substantially vertically and in that the cameras are fixed to said photographic chamber such that their optical axes are situated in an at least substantially horizontal plane at mid-height of said opening. The shell forms a console having said opening and incorporating said photographic chamber. In this embodiment, the console is at least substantially horizontal and has an at least substantially vertical opening.

Furthermore, advantageously and according to the invention, the lighting device is formed of a plurality of light sources emitting continuous white light and the photographic chamber has an inner surface of matt white colour.

More particularly, in an advantageous embodiment, each light source is formed of a white LED oriented towards said opening and of a non-transparent reflecting and/or diffusing screen interposed between the

LED and said opening. Such a screen may be completely reflecting so as to reflect the light emitted by each LED towards the inner surface of the photographic chamber, the latter reflecting and diffusing the light towards said opening so that said opening is lit by the lighting device with entirely indirect homogeneous white lighting. In a variant, there is nothing to prevent provision for each screen to be at least partially translucent so as to transmit a diffuse white light coming from each LED as direct lighting towards said opening. In other possible variant embodiments, each light source may be oriented in a direction different from said opening, so as to form indirect lighting of the latter by reflection/diffusion on said inner surface. In other possible variant embodiments, said inner surface may, by contrast, be coated with a light-absorbing, in particular black, coating and the different light sources are oriented directly towards said opening so as to form direct lighting—possibly via a translucent diffusing screen—of this opening.

Furthermore, according to an advantageous embodiment, said opening comprises a cutout provided in a transverse wall and having dimensions corresponding at least substantially to those of a human head of greatest possible dimensions. This cutout constitutes a natural guide for a human subject who can therefore place his or her head in said opening in a naturally optimum position. The inventors have found for this reason, with surprise, that in reality it was not necessary to impose an extremely precise placement of the subject's head with respect to the shell, and that a certain imprecision is admissible, in view, moreover, of the precision of the shots which are taken and of the algorithm for processing the digital images for obtaining the virtual model.

Advantageously, a device according to the invention comprises a supporting wall for supporting the cameras which extends in said shell along a convergent skew surface on one side and from a plane, called the frontal plane, containing said opening. In addition, advantageously and according to the invention, said transverse wall is a front wall extending along said frontal plane. Thus, the supporting wall, and the shell which bears it, are overall convergent from the transverse front wall from which said opening is cut out. In other words, their width and their height are constant or decrease from the frontal plane. For example, preferably and according to the invention the different cameras are arranged along a horizontal arc of a circle (along an angular sector less than a semi-circle) centred on a median vertical axis of said opening. Thus, the supporting wall for supporting the cameras is rotationally symmetrical about said median vertical axis of said opening and extends along a semi-circle or along an angular sector less than a semi-circle.

In a particularly advantageous application of the invention, a device and a method according to the invention are used for the three-dimensional digitisation of human faces, making it possible to obtain individual virtual models of human faces, in particular for the virtual trying of cosmetics, hairstyles, spectacles, etc.

The invention also relates to a device and a method characterised in combination by all or part of the features mentioned above or below.

Further objects, features and advantages of the invention will become apparent on reading the following description which is given without limitation and refers to the appended figures in which:

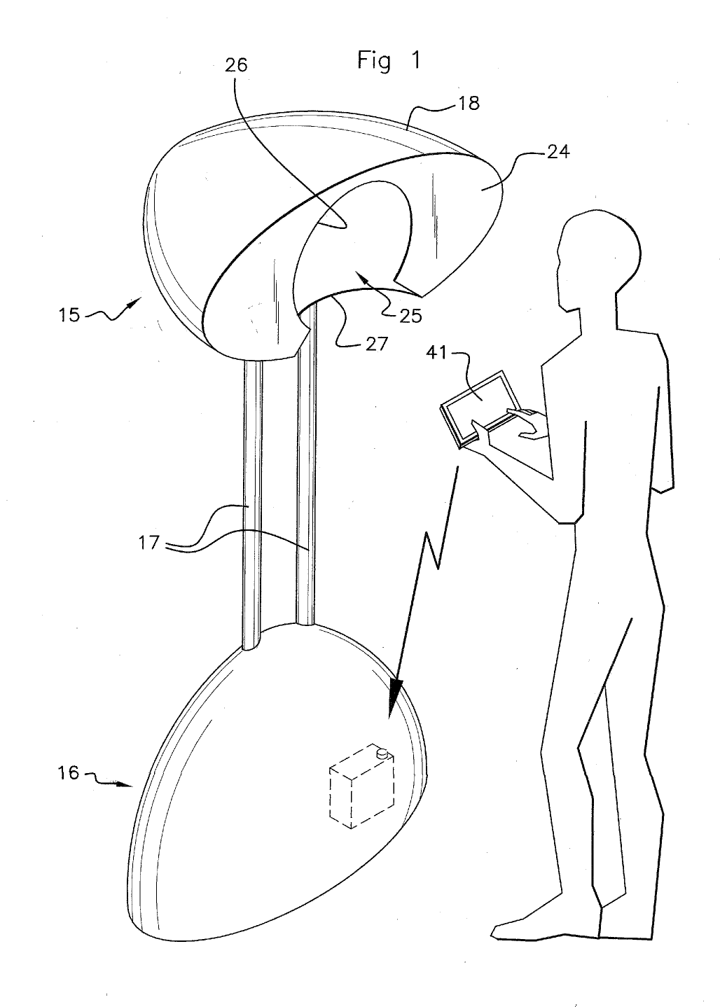

FIG. 1 is a schematic perspective view of a first embodiment of a device according to the invention,

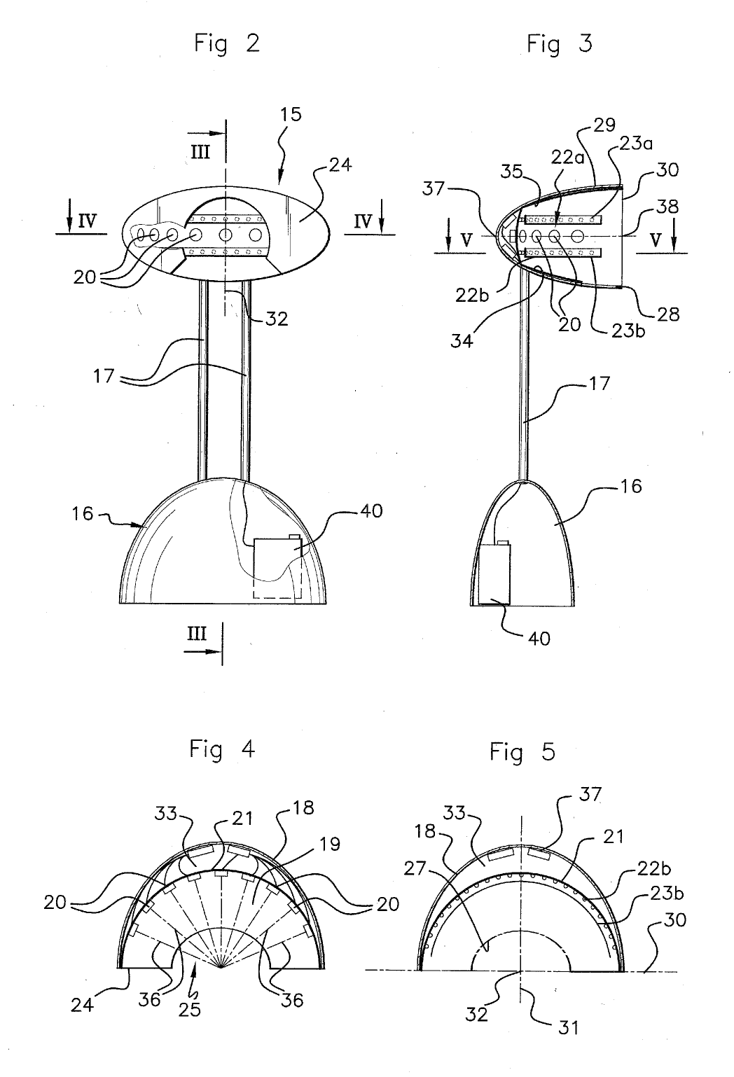

FIG. 2 is a schematic front view of the device of FIG. 1,

FIG. 3 is a schematic sectional view along the line III-III of FIG. 2,

FIG. 4 is a schematic sectional view along the line IV-IV of FIG. 2,

FIG. 5 is a schematic sectional view along the line V-V of FIG. 3,

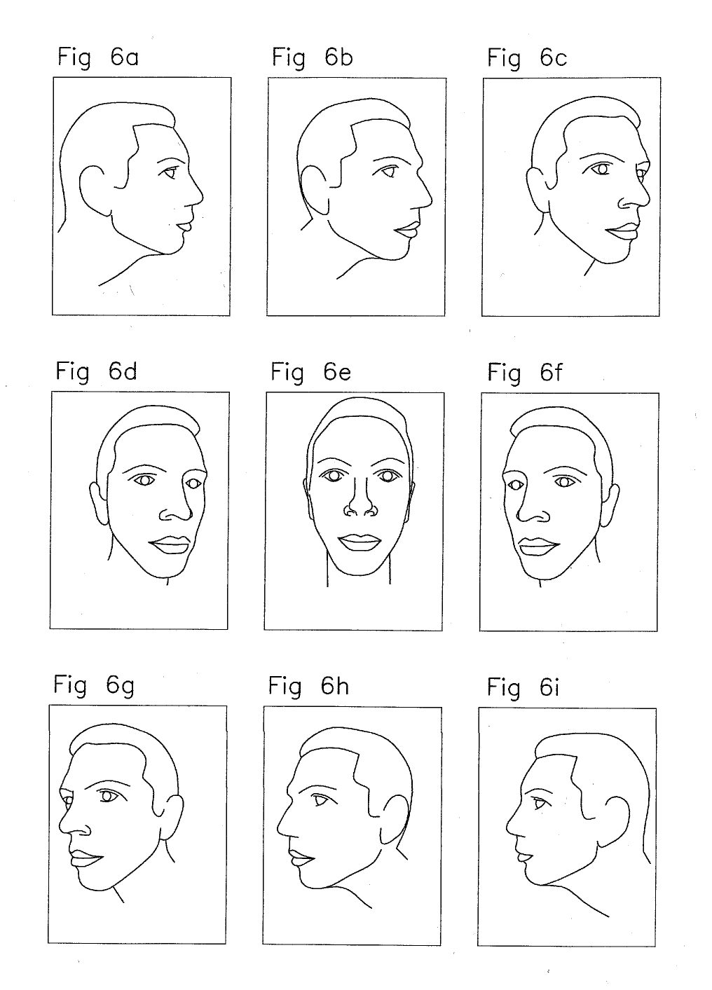

FIGS. 6a to 6i are schematic views illustrating an example of the different shots which can be taken by a device according to the first embodiment of the invention, and can be used to produce a three-dimensional virtual model of a face in a method according to the invention,

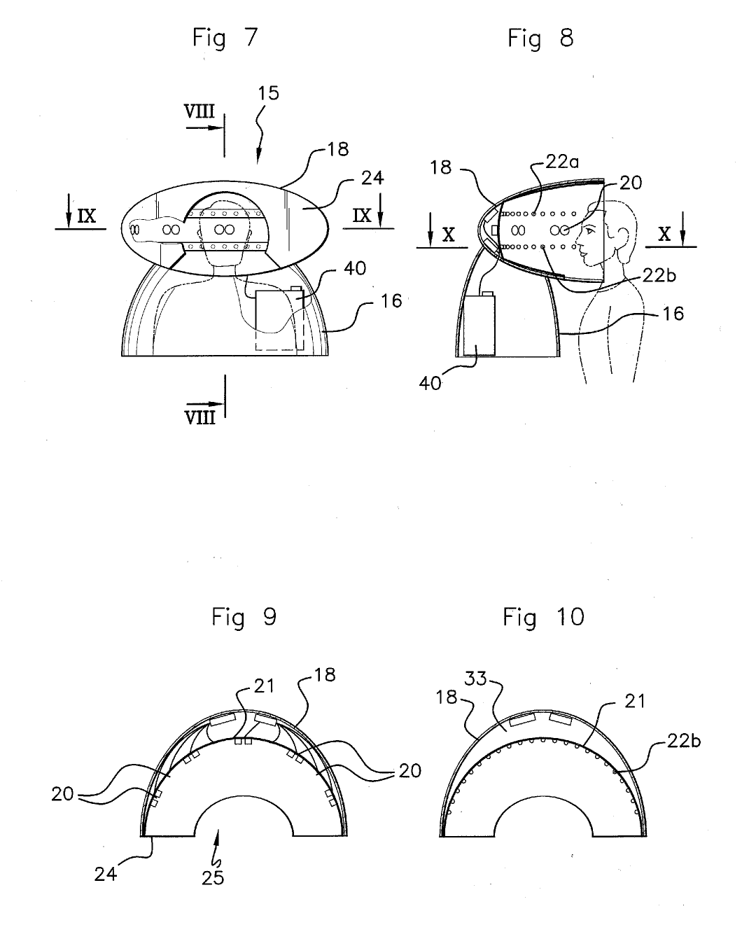

FIG. 7 is a schematic front view of a second embodiment of a device according to the invention,

FIG. 8 is a schematic sectional view along the line VIII-VIII of FIG. 7,

FIG. 9 is a schematic sectional view along the line IX-IX of FIG. 7.

FIG. 10 is a schematic sectional view along the line X-X of FIG. 8.

A device according to the first embodiment of the invention shown in FIGS. 1 to 5 comprises a photographic console 15, a base 16, and vertical uprights 17 connecting the base 16 to the photographic console 15 in order to support the latter at the height of the head of a human subject in the standing position. Preferably, the height of the photographic console 15 can be adjusted by sliding with respect to the vertical uprights 17, clamping means enabling it to be locked in position after adjustment.

The photographic console 15 comprises a hollow opaque rigid shell 18 forming a hollow photographic chamber 19 delimiting an internal space isolated from the outside light, with the exception of an opening 25 for receiving the head of a human subject. The shell 18 incorporates and supports a plurality of cameras 20 fixed rigidly with respect to the shell 18 in this photographic chamber 19. For this purpose, the cameras 20 are fixed rigidly directly on a rigid supporting wall 21, itself fixed rigidly inside the shell 18. The supporting wall 21 also supports a lighting device which is therefore likewise fixed rigidly with respect to the shell 18 (via the supporting wall 21) in the photographic chamber 19 in order to emit a homogeneous light in the visible range inside this chamber. In the example shown, the lighting device comprises two horizontal parallel alignments 22a, 22b of, preferably white, LEDs, each LED of each alignment being covered by a light reflecting/diffusing screen 23a, 23b, for example in the form of reflecting/diffusing strips 23a, 23b covering the alignments 22a, 22b of LEDs. For example, flexible ribbons of white LEDs marketed under the reference XANLITE® LSA-K1.5 by the company Yantec Gonesse, France, are used. According to another example, a flexible strip of LEDs including a diffuser itself, for example as marketed on http://www.neonflex.com.au, may be used to form each alignment.

The shell 18, which constitutes the outer wall of the console 15, may be formed from a rigid composite material and is of any, preferably pointed, shape, for example in the shape of an elliptical paraboloid or of an ellipsoid tip (especially a semi-ellipsoid resulting from an ellipsoid cut by a median transverse plane), or even a polyhedron. The shell 18 has a plane vertical front wall 24 extending along a frontal end plane (corresponding to the median transverse plane of section of the ellipsoid in the case where the shell 18 has the shape of a semi-ellipsoid), a lower wall 28, and an upper wall 29 which both extend from the front wall 24 as far as the vertex 37 of the elliptical paraboloid or the ellipsoid tip. The shell 18 also has the opening 25 suitable for receiving the head of a human subject. This opening 25 is formed of a cutout 26 provided in the front wall 24 and having dimensions corresponding at least substantially to the maximum size of a human head in the frontal plane of a human subject. In the example shown, the cutout 26 is a portion of a circle having a radius which may be between 12.5 cm and 25 cm, for example of the order of 17.5 cm.

The opening 25 also comprises a cutout 27 provided in the lower wall 28 of the shell 18 starting from the front wall 24, so as to enable the passage of the neck of the human subject, such that the head of this human subject can be inserted and placed in the opening 25 by presenting a peripheral cephalic portion, for example the face, extending so as to project into the interior of the photographic chamber 19 with respect to the front wall 24, this peripheral cephalic portion then being able to be subjected to shots by the cameras 20.

The shell 18 extends only on one side of said opening 25 while delimiting it entirely, and is overall symmetrical with respect to a median vertical plane, which may be termed the sagittal plane 31, orthogonal to the frontal plane 30 of the front wall 24. The intersection of these two planes 30, 31 defines a vertical axis 32, called the reference axis 32, which is also an axis of symmetry of the front wall 24 and of the cutout 26 forming the opening 25. In a variant not shown, the shell 18 may be formed of two moulded half-shells put together along said median vertical plane, but which can be fitted into each other for the purpose of transportation.

The supporting wall 21 extends overall along a surface of revolution extending over an angular sector of 180° about the reference axis 32. The supporting wall 21 may be a wall in the shape of a cylinder of revolution or is preferably slightly curved with a concavity oriented towards the opening 25 so as to better reflect and/or diffuse the light in the direction of this opening 25. The supporting wall 21, the trace of which in a median horizontal plane 38 of the semi-ellipsoid forming the shell 18 is preferably semi-circular, tangential to the shell 18 at its ends in the frontal plane 30, and extends at a distance from the shell 18 so as to provide a space 33 on the side of the vertex of the semi-ellipsoid forming the shell 18, which space 33 enables the passage of cables and/or connectors extending to the outside of the photographic chamber 19 for controlling and/or supplying power to the cameras 20 and the lighting device and/or the transmission of the photographic data from the cameras 20. In a variant not shown, the supporting wall 21 may have other shapes than that mentioned above and shown (the trace of which in a median horizontal plane is semi-circular), for example with a trace in a median horizontal plane in the shape of a portion of a parabola, or portion of an ellipse, or other shapes. That being said, the supporting wall 21 extends overall around and at a distance from the reference axis 32. The semi-circular shape, however, makes it possible to ensure that the different cameras 20 are all at the same distance from the reference axis 32, thereby facilitating adjustments to the design.

The supporting wall 21 is continued upwards by an upper wall 35 covering the upper wall 29 of the shell 18, and downwards by a lower wall 34 covering the lower wall 28 of the shell 18. The inner surfaces of the supporting wall 21, and those of the upper wall 35 and lower wall 34 which continue it, and also that of the front wall 24 constitute the inner surfaces of the photographic chamber 19 which extend only on one side of said opening 25 while delimiting it entirely. Preferably, these inner surfaces are of a matt white colour so as to reflect while diffusing the light coming from the lighting device. An isotropic white homogeneous lighting of the opening 25, and therefore of the peripheral cephalic portion extending into the photographic chamber 19 of a human subject whose head is placed in the opening 25, is thus obtained. It should be noted that the inner surfaces of the lower wall 34 and upper wall 35 are portions of concave skew surfaces adapted for providing a lighting as homogeneous and uniform as possible. To do this, the state of the surface of these walls is chosen so as to generate a Lambertian type reflection, that is to say with isotropic rediffusion. Consequently, a uniform lighting making it possible to create a neutral texture, without shadows, which is particularly preferable for the functioning of the algorithms for generating 3D geometry, especially for the correspondence of the homologous pixels, is obtained.

Each camera 20 has an optical axis 36. The cameras 20 are fixed on the supporting wall 21 so that their optical axes 36 are coplanar, extending in the median horizontal plane 38 of the shell 18, and oriented to converge towards said opening 25, at different angles from one another. The optical axes 36 of the cameras 20 are therefore situated at least substantially at mid-height of the opening 25. They are preferably oriented towards the vertical axis 32 and evenly distributed around the opening 25, that is to say separated from one another by identical angular sectors. In a variant, however, it is also possible to provide a different geometrical arrangement, depending on the applications or depending on the requirements and/or the characteristics of the algorithm subsequently used to produce, from the shots, a three-dimensional digital model of the peripheral cephalic portion. For example, the cameras 20 situated laterally (furthest away from the sagittal plane 31) may have their optical axes oriented towards the corresponding side of the opening 25, rather than the vertical axis 32.

The cameras 20 are arranged with a horizontal alignment at least substantially in the median horizontal plane, and the lighting device comprises a horizontal alignment 22a of LEDs situated above the alignment of the cameras 20 and a horizontal alignment 22b of LEDs situated below the horizontal alignment of the cameras 20. Preferably, the two alignments 22a, 22b of LEDs are both situated at the same vertical distance from the alignment of the cameras 20.

In a device according to the invention, each camera 20 may be formed of a webcam with a CMOS sensor having a resolution greater than one megapixel, for example of the order of five megapixels, and the lens of which possesses an optimum optical quality and optical characteristics suitable for producing a depth of field ensuring a sharpness of the images at the working distance. Preferably, each camera 20 is chosen so as to permit adjustment of its photographic characteristics, namely the exposure time and/or the aperture and/or the focusing distance. It should be noted, however, that the lighting device may be adapted to permit sufficient lighting that the depth of field of the camera 20 covers all of the distances that may separate a peripheral cephalic portion from this camera. Furthermore, the different cameras 20 have lenses of a size such that, in view of the distance of the cameras 20 away from the opening 25, each image produced by each camera 20 covers all of the opening 25 and of the peripheral cephalic portion extending into the interior of the photographic chamber 19. For example, the different cameras 20 have lenses chosen to produce clear shots between 15 cm and 50 cm. They advantageously have a wide field of view, in particular of between 60° and 90°, for example of the order of 80°. The lenses of the different cameras 20 are, moreover, preferably situated at a distance of between 10 cm and 100 cm, for example of the order of 40 cm, from the opening 25, so as in particular to limit the overall size of the console 15. It should be noted that the inner surface of the front wall 24 serves at least partly as a background for all the cameras 20 of the photographic chamber 19.

Furthermore, each camera 20 is chosen so as to possess sufficient sensitivity. Preferably, the different cameras 20 are identical. For example, each camera 20 is formed of a webcam with fixed focus adapted to the working distance and/or adjustable manually or by the data-processing unit 40.

In the example shown, the device comprises nine cameras 20 making it possible to produce nine photographs in the form of digital images, an example of which is shown schematically in FIGS. 6a to 6i. In practice, a device according to this first embodiment of the invention may comprise a different number of cameras, preferably between 6 and 12, for example equal to 7, 9 or 11.

The device according to the invention also comprises a digital data-processing unit 40, i.e. a central processing unit, accommodated in the base 16 and connected by cables passing preferably through the uprights 17 and to the cameras 20 and the lighting device of the photographic console 15. Preferably, the cameras 20 are webcams with high-speed universal serial connections, in particular of USB 2 type, each camera 20 being connected directly to a USB 2 port of the unit 40. Likewise, the lighting device is preferably controlled and/or supplied with electricity via the unit 40.

The data-processing unit 40 is adapted to control the simultaneous triggering of the different cameras 20, and possibly also the lighting device, under the control of an operator or automatically. It should be noted that the lighting device may be activated as soon as the digitising device according to the invention is started and be kept on permanently. In a first variant, the data-processing unit 40 comprises a man/machine interface, for example in the form of a digital tablet 41, connected by radiofrequency link to the unit 40, for example by Wifi. In a variant, the data-processing unit 40 may be adapted to detect the presence of a head in the opening 25 (from the images delivered by at least one of the cameras which may be permanently active and with appropriate image processing), and may automatically trigger the shots after waiting for a delay time of predetermined duration after detection of the presence of a head in the opening 25.

The use of a digital tablet 41 also advantageously makes it possible to check the quality of the photographs produced by the different cameras 20. It also makes it possible to visualise the three-dimensional digital model obtained from the different shots, and generated by the data-processing unit 40 which is adapted for this purpose, that is to say has an algorithmic program for producing a three-dimensional digital model from the nine shots. Such algorithmic programs are well known, and the invention may be used with any of these programs, subject to possible specific adjustments for optimising the operation of the device. Preferably, use is made of a passive digitising program of the dense type comprising a module for virtual reconstruction of the hidden side of the head, that is to say of the peripheral portion not shown on the shots taken by the different cameras 20. For example, use may be made of the PhotoModeler® program published by the company EOS Systems Inc., Vancouver, Canada.

The second embodiment shown in FIGS. 7 to 10 differs from the first embodiment in that the base 16 directly supports the console 15 and is adapted to be placed on a table, with the subject whose face is to be digitised sitting on a chair. Furthermore, the nine individual cameras of the first embodiment are replaced by five pairs of identical webcams 20 adapted to form five pairs of stereoscopic images simultaneously. The program VIC 3D® published by the company Correlated Solutions, Columbiad, S.C., USA makes it possible to obtain a virtual model from these stereoscopic photographs. Furthermore, the lighting device is formed solely of the alignments of LEDs, without a screen for covering the LEDs, producing direct lighting of the peripheral cephalic portion, inserted in the photographic chamber 19, of a human subject whose head is placed in the opening 25:

### EXAMPLE

A device in accordance with the first embodiment of the invention was produced with a shell 18 in the form of an elliptical paraboloid of 530 mm in depth with a front wall 24 of 400 mm in height, 810 mm in width, a supporting wall of 380 mm in radius, bearing nine USB2 webcams 20 marketed under the reference C910 HD by the company Logitech, Romanel sur Morge, Switzerland, separated from one another by about 100 mm, the webcams 20 closest to the front wall 24 being about 200 mm therefrom, the cutout 25 in the front wall 24 being a portion of a circle having a radius of 175 mm. The lighting device is formed as described above by two ribbons 22a, 22b of white LEDs each covered by a strip 23a, 23b of translucent matt white flexible PVC of 3 cm in height, 2 mm in thickness, and fixed at 14 mm from the supporting wall 21 by spacers. The inner surfaces of the photographic chamber 19 are of matt white colour.

The data-processing unit 40 comprises a quad-core Intel Core I5® processor, 4 GB RAM, a hard drive with a capacity greater than 100 GB, and USB2 ports. It was programmed with an algorithmic procedure producing a 3D geometry of the face formed of textured points, such as the program PhotoModeler® which is preconfigured for this purpose. The rear part of the head is obtained from this 3D geometry of the face and from a generic model of the human head obtained from 3D face modeling software. The generic model is deformed to fit the 3D face geometry and the rear part of the generic model is merged in 3D with said 3D face geometry. This gives, without optimisation of the software code, a virtual three-dimensional model of the face of a human subject, including the rear part of the head by virtual reconstruction in an average time of less than five minutes.

The invention may have numerous other variant embodiments with respect to the embodiments described above, the features of which may be combined wholly or partly with one another, and have diverse applications. In particular, although it is applied advantageously to obtaining a three-dimensional virtual model of a peripheral cephalic portion which comprises the face (with or without the ears), there is nothing to prevent provision for any other embodiment adapted to other applications, for example a console having an opening for receiving the subject's head which is not vertical, but rather, for example, horizontal or inclined, in particular in three-dimensional digitising applications for hair or other applications. Similarly, the exact shapes, the distribution and the choice of the supporting wall, of its interior covering, of the cameras, of the lighting device, of the opening for receiving the subject's head etc. may vary. The same applies to the data-processing unit 40, and more generally the data processing which may be wholly or partly transferred to a network server, for example accessible via the Internet.

A device according to the invention is, at all events, entirely preset and programmed during manufacture and/or on-site installation, and its use does not require any specific computing competence or any adjustment.

1. Device for three-dimensional digitisation of a human peripheral cephalic portion, comprising a plurality of cameras arranged to be able to take a plurality of shots from different viewpoints of at least part of said peripheral cephalic portion, said plurality of shots being adapted to enable the generation of a three-dimensional digital model of said peripheral cephalic portion from said plurality of shots, characterised in that it comprises a hollow opaque shell (18) having an opening (25) suitable for receiving the head of a human subject, said shell (18) forming a photographic chamber (19) incorporating and supporting:
a plurality of cameras (20) fixed in the photographic chamber (19) and oriented towards said opening,
a lighting device (22a, 22b, 23a, 23b) fixed in the photographic chamber (19) and adapted to light said opening (25) and at least one peripheral cephalic portion of the head of a human subject placed therein with a homogeneous and controlled light.

2. Device according to claim 1, characterised in that it further comprises a digital data-processing unit (40) connected to the cameras (20) and adapted to be able to generate, from said plurality of shots, a three-dimensional digital model of said peripheral cephalic portion.

3. Device according to claim 2, characterised in that said digital data-processing unit (40) is also adapted to be able to control the simultaneous triggering of the cameras (20).

4. Device according to claim 2, characterised in that said photographic chamber (19) extends only on one side of said opening (25) while delimiting it entirely, so that the cameras (20) are adapted to take shots only of one side of the head of a human subject oriented towards the interior of the photographic chamber (19) when this head is placed through said opening (25), and in that said data-processing unit (40) is adapted to produce a virtual reconstruction from a generic model of the opposite side of the head.

5. Device according to claim 4, characterised in that each camera (20) comprises at least one sensor having a resolution greater than one megapixel—in particular of the order of five megapixels—connected to said processing unit and controlled by the latter so as to deliver an image of a size which is less than its resolution—in particular of the order of a tenth of its resolution.

6. Device according to claim 1, characterised in that the cameras (20) are fixed in the photographic chamber (19) such that their optical axes (36) are coplanar and oriented to converge towards said opening (25) at different angles from one another.

7. Device according to claim 6, for the digitisation of faces, characterised in that said shell (18) is supported with respect to a support (16) so that said opening (25) extends at least substantially vertically and in that the cameras (20) are fixed to said photographic chamber (19) such that their optical axes (36) are situated in an at least substantially horizontal plane at mid-height of said opening (25).

8. Device according to claim 1, characterised in that the lighting device is formed of a plurality of light sources emitting continuous white light and in that the photographic chamber (19) has an inner surface of matt white colour.

9. Device according to claim 8, characterised in that each light source is formed of a white LED oriented towards said opening (25) and of a non-transparent reflecting and/or diffusing screen interposed between the LED and said opening (25).

10. Device according to claim 1, characterised in that it comprises a number of cameras (20) of between 6 and 12.

11. Device according to claim 1, characterised in that the different cameras (20) are fixed in the photographic chamber (19) so that their respective lenses are situated at a distance of between 10 cm and 100 cm from said opening.

12. Device according to claim 1, characterised in that said opening (25) comprises a cutout (26) provided in a transverse wall (24) and having dimensions corresponding at least substantially to those of a human head of greatest possible dimensions.

13. Device according to claim 1, characterised in that it comprises a supporting wall (21) for supporting the cameras (20) which extends in said shell (18) along a convergent skew surface on one side and from a plane, called the frontal plane, containing said opening (25).

14. Device according to claim 12, characterised in that said transverse wall (24) is a front wall extending along said frontal plane.

15. Method for three-dimensional digitisation of a human peripheral cephalic portion, with the aid of a device comprising a plurality of cameras (20) arranged to be able to take a plurality of shots from different viewpoints of at least part of said peripheral cephalic portion, said plurality of shots being adapted to enable the generation of a three-dimensional digital model of said peripheral cephalic portion from said plurality of shots, characterised in that:
the head of a human subject is received in the opening (29) of the shell (18) of a device according to claim 1,
said plurality of cameras (20) are triggered so as to take a plurality of shots of a peripheral cephalic portion of the head of a human subject received in the opening,
a three-dimensional digital model of said peripheral cephalic portion of said human subject is produced from said plurality of shots.

16. Device according to claim 3, characterised in that said photographic chamber (19) extends only on one side of said opening (25) while delimiting it entirely, so that the cameras (20) are adapted to take shots only of one side of the head of a human subject oriented towards the interior of the photographic chamber (19) when this head is placed through said opening (25), and in that said data-processing unit (40) is adapted to produce a virtual reconstruction from a generic model of the opposite side of the head.

17. Device according to claim 13, characterised in that said transverse wall (24) is a front wall extending along said frontal plane.
